(19) United States
(12) Patent Application Publication
(10) Pub. No.: US 2013/0218637 A1
(43) Pub. Date: Aug. 22, 2013

(54) SYSTEMS AND METHODS FOR COLLECTING AND ANALYZING CUSTOMER FEEDBACK INFORMATION

(71) Applicants: W. Jeremy Bikman, Alpine, UT (US); Chris O'Neal, Pleasant Grove, UT (US)

(72) Inventors: W. Jeremy Bikman, Alpine, UT (US); Chris O'Neal, Pleasant Grove, UT (US)

(73) Assignee: Katalus Advisors, LLC, Alpine, UT (US)

(21) Appl. No.: 13/400,525

(22) Filed: Feb. 20, 2012

(51) Int. Cl. G06Q 30/02

(52) U.S. Cl. 705/7.32; 705/7.29

(57) ABSTRACT

A computer-implemented method to analyze customer feedback information is described. A request is transmitted to one or more pre-selected entities to provide feedback information. The feedback information is received. Previously stored feedback information is retrieved from a data storage device. A trending pattern is determined based on the received feedback information and the stored feedback information.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet.

Many businesses use one or more computer networks to communicate and share data between the various computers connected to the networks. The productivity and efficiency of employees often require human and computer interaction. Users of computer technologies continue to demand an increase in the efficiency of these technologies. Improving the efficiency of computer technologies is always desirable to anyone who uses and relies on computers.

Computing systems may allow users to complete surveys relating to purchased goods and services. Users may provide a rating for a particular product or service using computing systems. The rating provided by users may influence the decision of other users that are deciding whether or not to purchase a particular good or service. Users may also leave comments regarding the good or service to further explain the particular rating assigned the user. The comments may provide a richer context of the user's position regarding the rated good or service. Ratings from multiple users may be calculated together to provide an average rating for the good or service. Current surveys, however, provide a static analysis of user's perception of the goods and services being rated.

### SUMMARY

According to at least one embodiment, a computer-implemented method to analyze customer feedback information is described. A request is transmitted to one or more pre-selected entities to provide feedback information. The feedback information is received. Previously stored feedback information is retrieved from a data storage device. A trending pattern is determined based on the received feedback information and the stored feedback information.

In one embodiment, trending data representing the trending pattern is generated. The received feedback information may be stored in the data storage device. In one example, a list of one or more entities may be received.

A response rate may be set for the one or more pre-selected entities. In one configuration, a contact frequency for the one or more pre-selected entities may be established. Contact information for one or more recipients of alert notifications relating to the feedback information may be received.

In one embodiment, the request to the one or more pre-selected entities includes a uniform resource locator (URL) to a validation webpage that comprises information relating to the one or more pre-selected entities. The request to the one or more pre-selected entities may include a security token. The security token may provide access to one or more survey questions.

A computing device configured to analyze customer feedback information is also described. The computing device may include a processor and memory in electronic communication with the processor. The memory may store computer executable instructions that when executed by the processor cause the processor to perform the steps of transmitting a request to one or more pre-selected entities to provide feedback information, receiving the feedback information, retrieving previously stored feedback information from a data storage device, and determining a trending pattern based on the received feedback information and the stored feedback information.

A computer-program product for analyzing customer feedback information is also received. The computer-program product may include a non-transitory computer-readable storage medium storing computer executable instructions that when executed by a processor cause the processor to perform the steps of transmitting a request to one or more pre-selected entities to provide feedback information, receiving the feedback information, retrieving previously stored feedback information from a data storage device, and determining a trending pattern based on the received feedback information and the stored feedback information.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one embodiment of a customer engagement platform (CEP) in accordance with the present systems and methods;

FIG. 3 is a block diagram illustrating a further embodiment of the CEP;

FIG. 4 is a block diagram illustrating a further embodiment of the CEP;

FIG. 5 is a block diagram illustrating a further embodiment of the CEP;

FIG. 6 is a flow diagram illustrating one embodiment of a method to provide customer feedback information in accordance with the present systems and methods;

FIG. 7 is a flow diagram illustrating one embodiment of a method to establish settings for the CEP; and

FIG. 8 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Vendors that provide goods or services may desire to gather intelligence from their customers in order to know the current conditions (e.g., satisfaction level, purchasing patterns, etc.) of their customers. Vendors may also desire to gather feedback information from customers to quickly uncover relevant trends and patterns within their customer base. Currently, vendors typically gather customer intelligence by doing one or more of the following: 1) Create an internal market intelligence gathering mechanism that includes one or more employees whose job it is to contact customers and ask questions regarding their experiences and opinions, 2) Hire a market research company to perform the intelligence gathering functions, and 3) Use online tools (e.g., survey tools, online forums, social networks, etc.) to gather information.

Using these current methods may create a host of problems. For example, internal market intelligence groups are expensive to maintain (head count) and may be inherently biased due to the information being internally generated. Market research firms are notoriously expensive and the information they generate may be dated because of how long it takes them to accomplish the research. Online methods may return very spotty data which may not be translated into actionable steps. Further, current survey tools have been designed for a business-to-consumer environment and are not suited for business-to-business dynamics.

The present systems and methods provide a cloud based solution to allow clients, such as information technology (IT) vendors, consultants, etc. to query, analyze, and understand their own customer base with more frequency, with greater participation, and more accuracy than current survey tools. The cloud based solution of the present systems and methods are both web based and mobile native, etc. The present systems and methods may assist a client to engage a high percentage of their customers and receive real time intelligence on relevant trends affecting their customer base. This will further provide the client with information regarding their own success. This flexible solution may be built on a platform which may be optimized to help the client discover pertinent information regarding their customer base, whether regarding issues of customer satisfaction, competitive analysis, product management, market intelligence, etc.

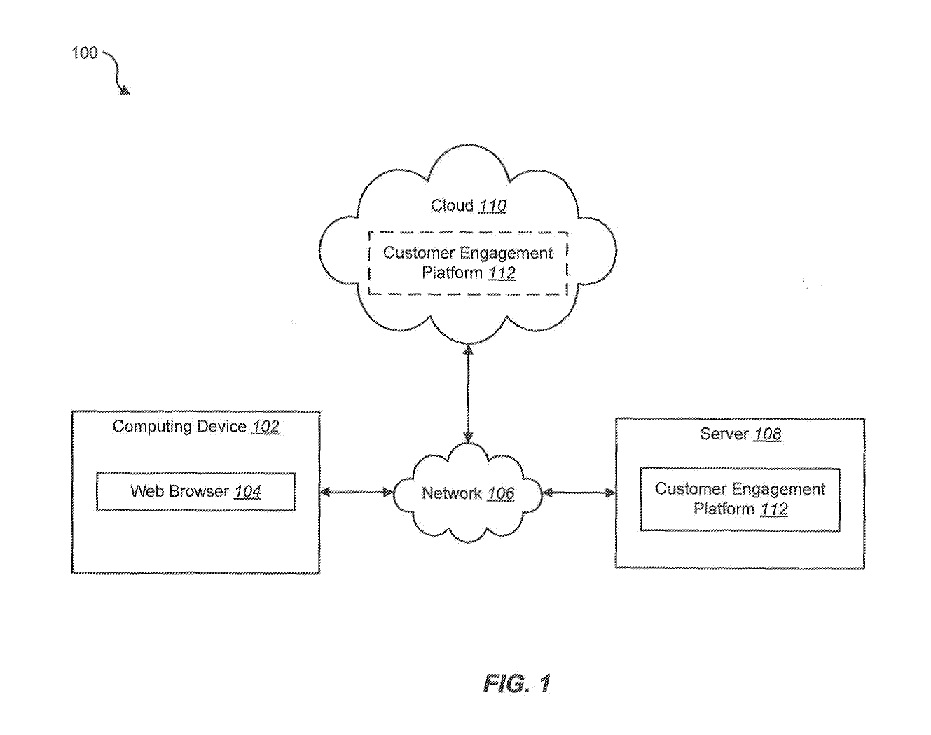

FIG. 1 is a block diagram illustrating one embodiment of an environment 100 in which the present systems and methods may be implemented. In one configuration, a computing device 102 may communicate with a cloud 110 and/or a server 108. The computing device 102 may be a personal computer (PC), a laptop, a tablet, a smart phone, or any other type of computing device.

In one example, the computing device 102 may include a web browser 104. The browser 104 may be an application installed on the computing device 102 to acquire and information from, for example, the Internet. The web browser 104 may display the acquired information to a user of the computing device 102. In one configuration, the web browser 104 may acquire information from the cloud 110 via the network 106. The network 106 may be a cellular network, a Wi-Fi network, a Wireless Local Area Network (WLAN), and the like.

The cloud 110 may provide cloud-based computing services. Cloud computing may be the delivery of computing as a service rather than a product, whereby shared resources, software, and information may be provided to computers, such as the computing device 102, as a metered service over the network 106. Cloud computing may provide computation, software, data access, and storage resources without requiring cloud users to know the location and other details of the computing infrastructure. In one configuration, end users may access applications stored within the cloud 110 through the web browser 104 or a light weight desk top or mobile application while the business software and data may be stored on servers at a remote location, such as the server 108.

In one configuration the cloud 110 may include a customer engagement platform (CEP) 112. The CEP 112 may be physically stored on the server 108. In one embodiment, the web browser 104 may access the CEP 112 directly from the cloud 110 via the network 106. In another example, the computing device 102 may communicate with the server 108 across the network 106 to access the CEP 112.

The CEP 112 may provide an interface for vendors as well as the vendor's customers. In one embodiment, vendors and customers may interface with the CEP 112 via the web browser 104. The vendors may interface with the CEP 112 to request certain information from their customers. The vendors may also interact with the CEP 112 to specify certain parameters for the data. Similarly, customers may access the CEP 112 via the web browser 104 to provide the requested information. The CEP 112 may analyze the information received from the customers and provide analytics and other representations of data that illustrate the information from the customers. In one example, the vendors may request feedback information from their customers relating to specific goods, services, etc. provided by the vendor. The customers may provide the feedback information by interfacing with the CEP 112 via the web browser 104. The CEP 112 may analyze the received feedback information and provide an analysis of the feedback information to the vendors via the web browser 104. The terms “vendors” and “customers” used herein may represent entities, such as companies, businesses, government agencies, educational institutions, and the like. Details regarding the CEP 112 will be described below.

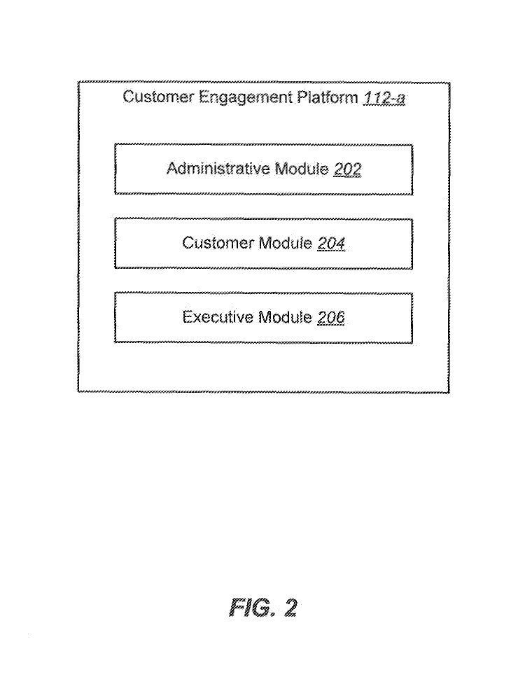

FIG. 2 is a block diagram illustrating one embodiment of a CEP 112-a. The CEP 112-a may be an example of the CEP 112 illustrated in FIG. 1. In one configuration, the CEP 112-a may include an administrative module 202, a customer module 204, and an executive module 206. The CEP 112-a may allow vendors to specify certain settings or parameters regarding the structure, type, etc. of feedback information requested from customers. The CEP 112-a may also provide an interface for the customers to provide the feedback information requested by the vendors. Further, the CEP 112-a may analyze the data received from customers and provide a summary of the analysis to the vendors.

In one embodiment, the administrative module 202 may provide an interface to vendors to allow the vendors to establish certain settings or parameters relating to the feedback information. For example, a vendor may upload a list of customers to the CEP 112-a via the administrative module 202. The list of customers may include contact information (e.g., name, address, telephone number, email address, position within a company, company name, company address, etc.). The vendor may also designate a response rate via the administrative module 202. The response rate may represent the proportion or percentage of the vendor's customer base that the vendor would like to contact via the CEP 112-a. The response rate may also indicate the percentage of customers the vendor would like to receive actual feedback information. For example, using the administrative module 202, the vendor may upload a customer list that includes 300 customers. The vendor may then designate the response rate (or a minimum threshold) that indicates the number of customers the vendor would like to solicit feedback information from by using the CEP 112-a and the percentage of responses that the vendor would like to receive from the customers that were contacted. For example, the vendor may specify that the CEP 112-a should contact 200 of the 300 customers on the list. The response rate may indicate that the vendor would like to receive feedback information back from at least 45% of the contacted customers.

The vendor may also specify a contact frequency for their customers using the administrative module 202. The contact frequency may represent how often the CEP 112-a contacts the customers of the vendor. The contact may include the CEP 112-a sending a request for feedback information. The vendor may establish the contact frequency to be quarterly, biannually, annually, etc. The contact frequency may vary from one customer to another customer.

The administrative module 202 may further allow a vendor to designate one or more recipients of alert notifications. For example, the CEP 112-a may receives text as part of the feedback information from customers. The CEP 112-a may analyze the words of the text to determine whether the feedback information should be classified as negative or positive. For example, words such as, but not limited to, “bad”, “poor”, “delay”, etc. may be classified as negative feedback. Further, the feedback information may include a rating, such as, but not limited to, a customer satisfaction rating. The CEP 112-a may analyze the rating to determine whether the feedback information should be classified as negative or positive. Based upon the classification of the feedback information, the CEP 112-a may send a notification alert to one or more recipients designated by the vendor via the administrative module 202. For example, a customer may provide a negative feedback regarding the vendor. Upon receiving the feedback information, the CEP 112-a may analyze the information and classify the feedback information as negative. The CEP 112-a may generate a notification email, text message, or other notification means to send to the one or more recipients of the notification alerts. As a result, the vendor may become aware of negative feedback in real time by receiving these notification alerts. The vendor may specify that notification alerts are to be sent each time negative feedback is received, when positive feedback is received, when a satisfaction rating falls below a certain threshold, when the change in satisfaction rating from one time period to a second time period satisfies a threshold, and the like. The vendor may provide the contact information of the recipients of the notification alerts. For example, the vendor may specify that a notification alert should be sent to a particular individual that is a member of the vendor (e.g., enterprise, business, company, entity, etc.) when a certain number of negative and/or positive feedback is received at the CEP 112-a.

The vendor may also establish one or more survey questions via the administrative module 202 to transmit to customers. For example, the vendor may input a survey question and select one or more customers from the uploaded customer list that should receive the survey question. As a result, the vendor may dynamically select specific customers from the uploaded customer list to receive specific survey questions inputted by the vendor.

The CEP 112-a may further include the customer module 204. The customer module 204 may interface with the customers to solicit and receive feedback information from the customers. In one embodiment, the customer module 204 may provide a message requesting a customer to provide feedback regarding a particular good or service of the vendor. The customer module 204 may display or provide one or more survey questions directed to the customer regarding the goods or services of the vendor. As previously explained, the one or more survey questions may originate from the vendor of the goods or services. The customers may interface with the customer module 204 to input answers to the survey questions and/or provide additional feedback information. For example, the customer module 204 may present a selection of various customer satisfaction ratings. The customer may select one or more of the ratings using the customer module 204.

In one embodiment, the executive module 206 may provide an interface whereby a vendor may view and interact with data (such as the feedback information) received from customers. For example, the executive module 206 may analyze feedback data received from customers via the customer module 204. Based on the analysis, the executive module 206 may summarize the data provide the summary to the vendor via the executive module 206. Details regarding the customer module 204 and the executive module 206 will be described below.

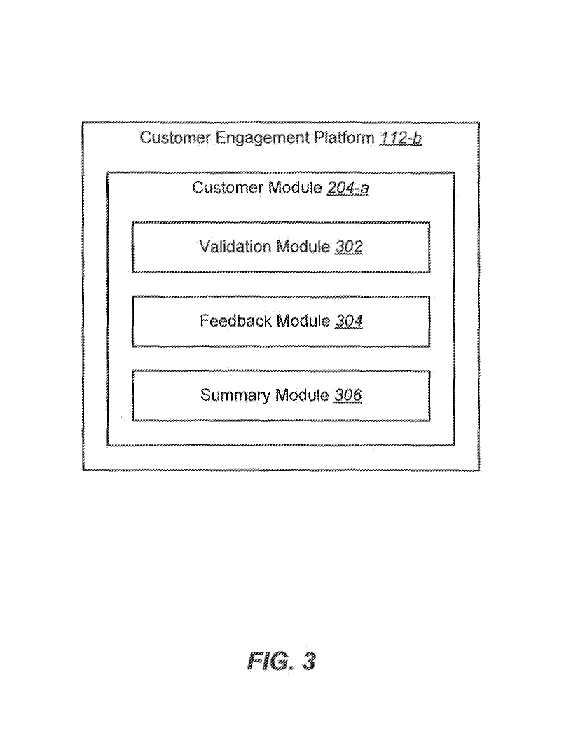

FIG. 3 is a block diagram illustrating one embodiment of a CEP 112-b. The CEP 112-b may be an example of the CEP 112 illustrated in FIG. 1 or 2. In one embodiment, the CEP 112-b may include a customer module 204-a. The customer module 204-a may include a validation module 302, a feedback module 304, and a summary module 306.

In one embodiment, the validation module 302 may provide a validation page to a customer whereby the customer may view, confirm, and edit information relating to the customer. For example, a customer may be requested to provide feedback regarding a particular vendor. The request may be sent to the customer via email, text, instant message, and the like. The customer may access the customer module 204-a and view the validation page provided by the validation module 302. The validation page may include contact information for the customer, such as, but not limited to, address, telephone number, email address, company address, company name, title, and the like. The customer may then view the contact information and validate the information, if the information is correct. The customer may also edit the information to correct any mistakes or if the information is outdated and should be updated. In one embodiment, the validation page 302 may request that the customer validate the location (or address) of the customer's business.

In one embodiment, the validation module 302 may transmit a message to the customer that includes a uniform resource locator (URL) or other link to the validation page. The customer may click on the link and access the validation page. The message may further include a security token or other unique identification token. The validation page may request the customer to enter the security token to access the remaining contents of the validation page (e.g., contact information of the customer, etc.). If the customer does not enter the proper credentials, the CEP 112-b may not provide the feedback survey questions via the feedback module 304 (explained below) to the customer.

The feedback module 304 may provide one or more survey questions to the customer. The survey questions provided by the feedback module 304 may have been previously created by the vendor for each particular customer, or for a particular group of customers. The survey questions may also be suggested by the CEP 112-b itself. The customer may provide answers to the survey questions via the feedback module 304. The answers may include text, selection of a satisfaction rating, and the like. The feedback module 304 may also provide the customer with the option to request whether or not to be contacted by the vendor in the future. The feedback module 304 may further allow the customer to request an immediate audience with the vendor, such as via telephone, email, instant messaging, video conference, and the like.

In one example, the summary module 306 may allow the customer to view a summary of data that has been collected previously by the customer and/or from other customers. For example, a customer may interface with the summary module 306 and request to view answers to previous survey questions that the customer previously provided via the feedback module 304. The customer may also interface with the summary module 306 to request to view answers and/or other data submitted by other customers of the vendor via the feedback module 304.

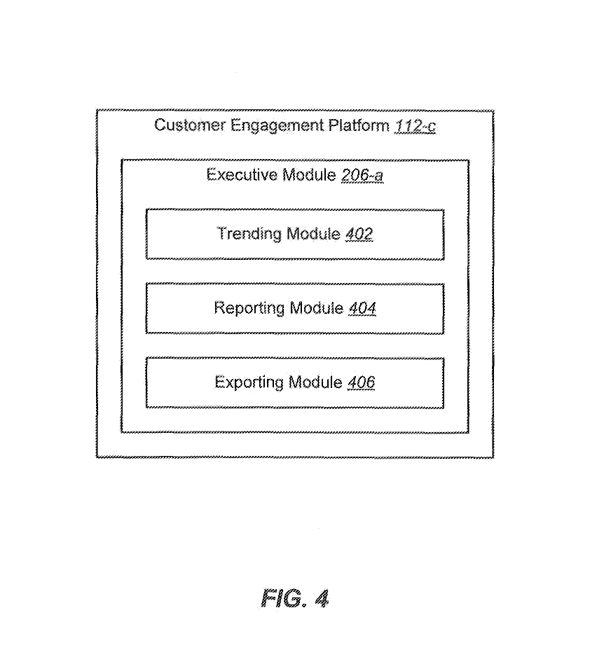

FIG. 4 is a block diagram illustrating one embodiment of a CEP 112-c. The CEP 112-c may be an example of the CEP 112 illustrated in FIG. 1, 2 or 3. In one embodiment the CEP 112-c may include an executive module 206-a. The executive module 206-a may include a trending module 402, a reporting module 404, and an exporting module 406. The executive module 206-a may represent a dashboard application and/or a web portal displayed on, for example, the computing device 102 such as a tablet, a PC, a laptop, a smartphone, and the like via the web browser 104. The executive module 206-a may be accessed via the web browser 104 and/or the module 206-a may be a standalone application installed on the computing device 102. The executive module 206-a may analyze the feedback data as it is received from the feedback module 304. A vendor may access the executive module 206-a to view real-time updates of analytics regarding the feedback information as it is received via the feedback module 304. In one embodiment, the feedback information (and the analytical summaries) may be accessible via the executive module 206-a before and after the response rate (described above) has been satisfied.

In one embodiment, the trending module 402 may provide an interface to the vendor to view a summary of an analysis of the feedback information received from customers. In one embodiment, the trending module 402 may generate and display various trending charts that may provide a visual depiction or illustration of trending patterns resulting from the feedback information received from one or more customers of the vendor. For example, the trending module 402 may provide satisfaction scores calculated from the feedback information received from the customers, geographic breakouts of feedback information received from certain geographic locations, customer demographics based on the location of the customers, and the like. The trending module 402 may generate graphs, charts, etc. that illustrate trending patterns that illustrate the real-time shifts in customer satisfaction, purchasing patterns, demographic changes of the customer base, and the like. For example, the CEP 112-c may transmit survey questions to a customer base in a fist quarter of a calendar year. The responses to the questions may be received and saved. During the second quarter of the same calendar year, the survey questions may again be sent to the customer base. As responses are received, the trending module 402 may create graphs, charts, and other visual displays that illustrate trending patterns of the customer base from the first quarter of the year to the second quarter. The trending module 402 may allow the vendor to specify that trending patterns for certain geographic regions should be displayed. For example, the vendor may specify that trending patterns of a certain state or region should be displayed. In addition, the trending module 402 may display a comparison of trending patters from different geographic regions, time periods, and the like.

The trending patterns may be represented by icons (such as upward or downward arrows) that indicate the trending directly of certain feedback information. For example, during the first quarter of a calendar year, the satisfaction scores of the customer base may represent a score of 7 out of 10. During the second quarter, the scores may represent 8 out of 10. The trending module 402 may generate an upward arrow, or some other indicator, to indicate to the vendor that the satisfaction score for the vendor's customer base is trending upwards from the first quarter to the second quarter of the year. In addition to icons, graphs or other charts may be generated by the trending module 402 to visually represent trending patterns. Alert notifications may be transmitted to the vendor when certain trending patterns are detected (e.g., trending upwards or downwards). As a result, the trending module 402 allows vendors to know in real-time the trending patters of its customer base over certain time periods, across different geographic locations, and the like.

In one embodiment, the reporting module 404 may provide drill down reports which may include text of customer comments included in the feedback information, specific regional trends, customer trending, and the like. A vendor may view these drill down reports via the reporting module 404 and determine why a particular trend generated by the trending module 402 may have occurred. For example, the trending module 402 may indicate to a vendor that a first geographic region is experiencing a lower satisfaction score than a second geographic region. An alert notification may be sent to the vendor, and the vendor may access a drill down report via the reporting module 404 to locate possible negative feedback information that may have been provided by one or more customers in the first geographic location. As a result, a vendor may take immediate action to remedy the cause of the negative feedback information received from one or more customers in the first region.

In one embodiment, the exporting module 406 may allow the vendor to export the data, the summary of the data, the analysis of the data, etc. provided by the various modules of the CEP 112-c to one or more formats, such as Excel, PDF, Word, and the like for further analysis. The exporting module 406 may also allow the data to be transmitted via an email message, text message, instant message, and the like.

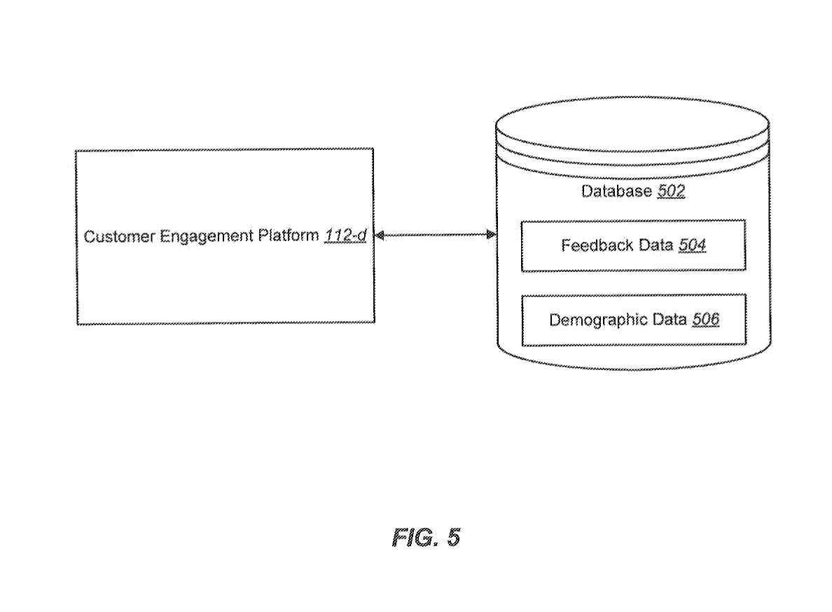

FIG. 5 is a block diagram illustrating one embodiment of a CEP 112-d communicating with a database 502. In one embodiment the CEP 112-d may be an example of the CEP 112 of FIG. 1, 2, 3 or 4. Although the database 502 is illustrated as being separate and distinct from the CEP 112-d, it is to be understood that the database 502 may be part of and integrated within the CEP 112-d.

In one embodiment, the database 502 may include feedback data 504 and demographic data 506. The feedback data 504 may include feedback information that has been previously received from one or more customers of a vendor. The demographic data 506 may include demographic information that may have been previously stored relating to the one or more customers of the vendor. In one configuration the CEP 112-d may access the data stored in the database 502 during an analysis of currently received feedback information. For example, the CEP 112-d may receive feedback information from a customer. The CEP 112-d may then access stored feedback data 504 that has been previously received from the customer during an early time period. The CEP 112-d may then analyze the current feedback information with the previously stored feedback data 504 and generate trending patterns based on the trend of the customer over a certain period of time. The stored demographic data 506 may also provide trending patterns indicating the past history of feedback information from certain regions where customers of the vendor are located. As a result, the database 502 may store past feedback information to generate trending patters for the vendor to recognize patters in customer satisfaction, purchasing history, and the like.

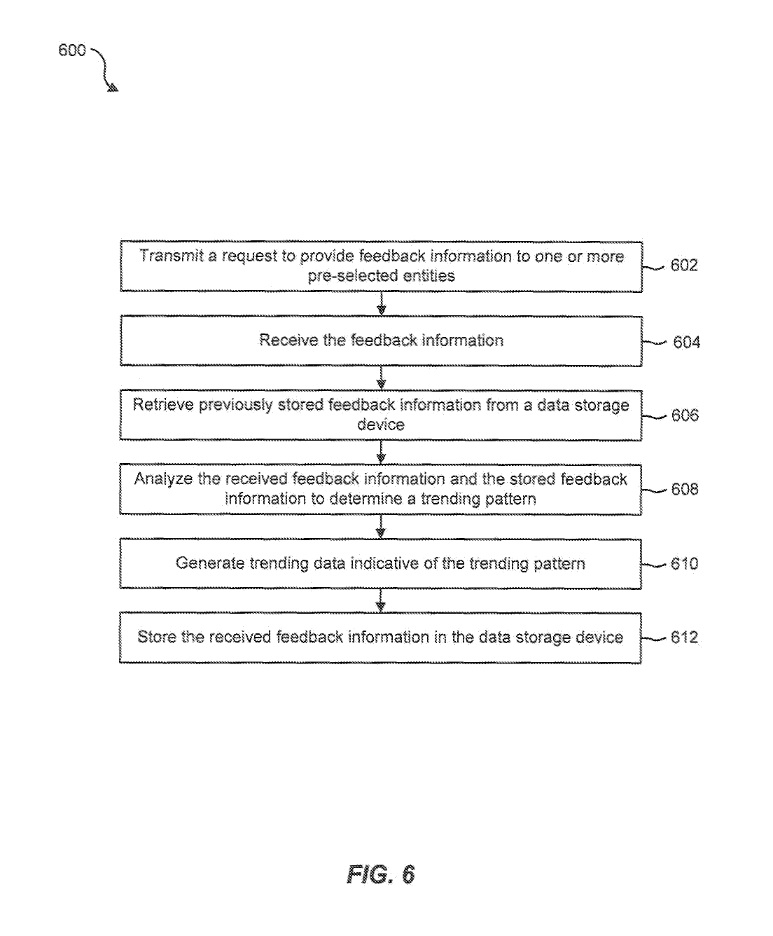

FIG. 6 is a flow diagram illustrating one embodiment of a method 600 to provide customer feedback information. In one configuration, the method 600 may be implemented by the CEP 112 of FIG. 1, 2, 3, 4, or 5.

At step 602, a request to provide feedback information to one or more preselected entities may be transmitted. For example, a vendor may access the CEP 112 to provide one or more customer lists. The vendor may then select one or more customers included on the list. The vendor may desire to receive feedback information from the selected one or more customers. The request for feedback information may be sent or transmitted to the one or more selected customers via email, text, instant message, and the like. At step 604, the feedback information may be received from the selected customers. At step 606, previously stored feedback information may be retrieved from a data storage device, such as a database. The previously stored feedback information may have been received from the selected customers at an early time period. In addition, the previously stored feedback information may have been received from other customers (i.e., non-selected customers) from the list. In addition, the previously stored feedback information may have been received from one or more customers not included on the vendor's customer list.

At block 608, the received feedback information and the stored feedback information may be analyzed to determine a trending pattern. The trending pattern may indicate trending patterns in satisfaction scores for the vendor, trending patterns in customer demographics, trending patterns in purchasing history, and the like. At block 610, trending data indicative of the trending pattern may be generated. The trending data may include graphs, flow charts, and the like that visually illustrate the trending patterns determined from the feedback information currently received and stored feedback information. At block 612, the feedback information currently received may be stored in the data storage device, such as the database. The feedback information may be stored for future retrieval during the analysis of future feedback information received from customers to determine real-time trending patterns of the customers.

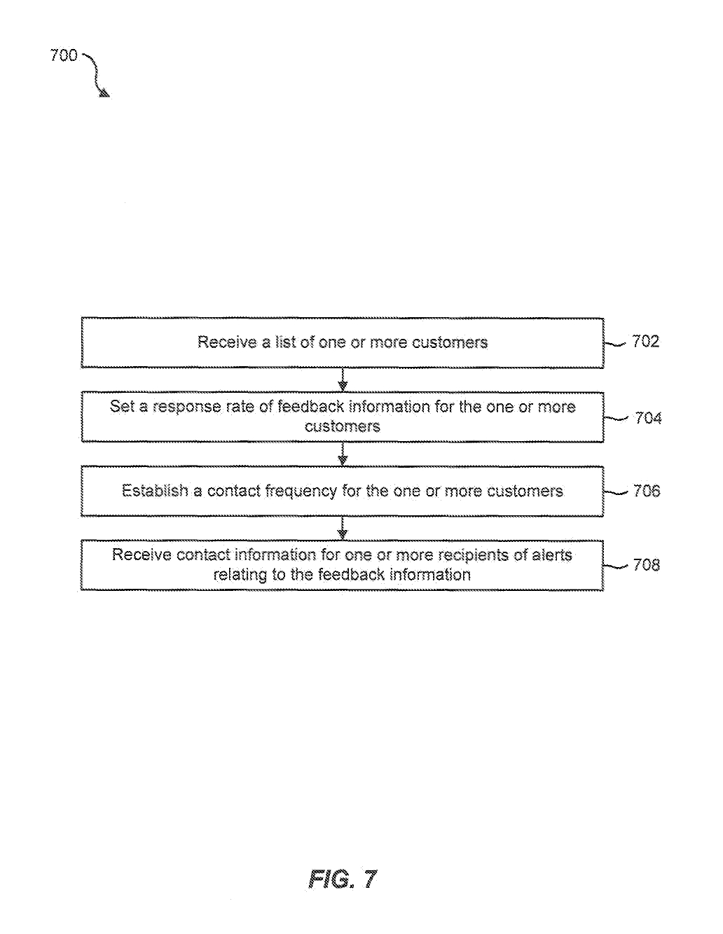

FIG. 7 is a flow diagram illustrating one embodiment of a method 700 to establish settings for the CEP 112. In one embodiment, the method 700 may be implemented by the CEP 112 of FIG. 1, 2, 3, 4, or 5. In particular, the method 700 may be implemented by the administrative module 202 of FIG. 2.

At block 702, a list of one or more customers may be received. At block 704, a response rate of feedback information may be set or established for the one or more customers. At block 706, a contact frequency may be established for the one or more customers. The contact frequency may indicate how often the CEP 112 may transmit a request to the customers to provide feedback information. At block 708, contact information for one or more recipients of notification alerts may be received. For example, a vendor may provide contact information for one or more members of the vendor (e.g., business, company, etc.) that may receive alerts when certain trending patterns are detected from the feedback.

In one embodiment, as described above, the present systems and methods may be built on a flexible platform which allows a client, such as a vendor, corporation, government agency, educational institutional, financial institution, etc. to engage its customer base in varying ways with different questions. For example, the vendor may inquire about general customer satisfaction, while a follow-up inquiry might ask customers about future buying plans, while another inquiry may delve into reactions to new government regulations from the viewpoint of the customers. In addition, the present systems and methods may provide survey tools that retain a database of past answers or customer demographics. As a result, over time, the present systems and methods may compile a database of past data and customer feedback information which may be utilized for data analytics and predictive trending of trending patterns.

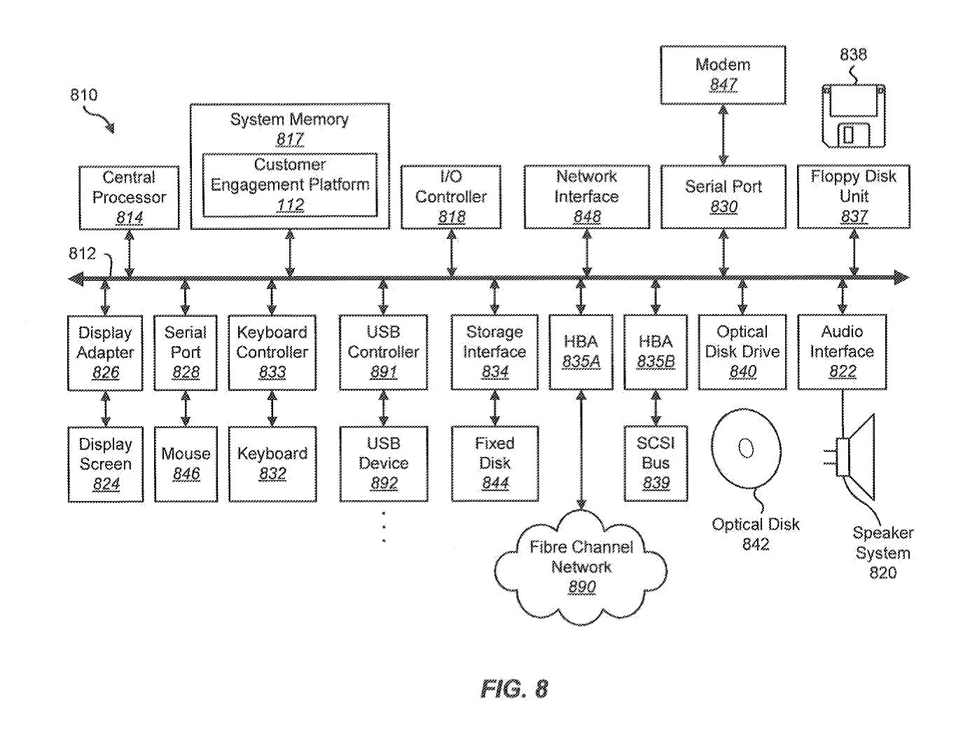

FIG. 8 depicts a block diagram of a computer system 810 suitable for implementing the present systems and methods. Computer system 810 includes a bus 812 which interconnects major subsystems of computer system 810, such as a central hardware processor 814, a system memory 817 (typically RAM, but which may also include ROM, flash RAM, or the like), an input/output controller 818, an external audio device, such as a speaker system 820 via an audio output interface 822, an external device, such as a display screen 824 via display adapter 826, serial ports 828 and 830, a keyboard 832 (interfaced with a keyboard controller 833), multiple USB devices 892 (interfaced with a USB controller 891), a storage interface 834, a floppy disk unit 837 operative to receive a floppy disk 838, a host bus adapter (HBA) interface card 835A operative to connect with a Fibre Channel network 890, a host bus adapter (HBA) interface card 835B operative to connect to a SCSI bus 839, and an optical disk drive 840 operative to receive an optical disk 842. Also included are a mouse 846 (or other point-and-click device, coupled to bus 812 via serial port 828), a modem 847 (coupled to bus 812 via serial port 830), and a network interface 848 (coupled directly to bus 812).

Bus 812 allows data communication between central processor 814 and system memory 817, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the CEP 112 to implement the present systems and methods may be stored within the system memory 817. The CEP 112 may be an example of the CEP 112 illustrated in FIG. 1, 2, 3, 4, or 5. Applications resident with computer system 810 are generally stored on and accessed via a non-transitory computer readable medium, such as a hard disk drive (e.g., fixed disk 844), an optical drive (e.g., optical drive 840), a floppy disk unit 837, or other storage medium. Additionally, applications can be in the form of electronic signals modulated in accordance with the application and data communication technology when accessed via network modem 847 or interface 848.

Storage interface 834, as with the other storage interfaces of computer system 810, can connect to a standard computer readable medium for storage and/or retrieval of information, such as a fixed disk drive 844. Fixed disk drive 844 may be a part of computer system 810 or may be separate and accessed through other interface systems. Modem 847 may provide a direct connection to a remote server via a telephone link or to the Internet via an internet service provider (ISP). Network interface 848 may provide a direct connection to a remote server via a direct network link to the Internet via a POP (point of presence). Network interface 848 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 8 need not be present to practice the present systems and methods. The devices and subsystems can be interconnected in different ways from that shown in FIG. 8. The operation of a computer system such as that shown in FIG. 8 is readily known in the art and is not discussed in detail in this application. Code to implement the present disclosure can be stored in a non-transitory computer-readable medium such as one or more of system memory 817, fixed disk 844, optical disk 842, or floppy disk 838. The operating system provided on computer system 810 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.”

What is claimed is:

1. A computer-implemented method to analyze customer feedback information, comprising:
transmitting, by a hardware processor, a request to one or more pre-selected entities to provide feedback information;
receiving, by the hardware processor, the feedback information;
retrieving, by the hardware processor, previously stored feedback information from a data storage device; and
determining, by the hardware processor, a trending pattern based on the received feedback information and the stored feedback information.

2. The method of claim 1, further comprising generating trending data representing the trending pattern.

3. The method of claim 1, further comprising storing the received feedback information in the data storage device.

4. The method of claim 1, further comprising receiving a list of one or more entities.

5. The method of claim 1, further comprising setting a response rate for the one or more pre-selected entities.

6. The method of claim 1, further comprising establishing a contact frequency for the one or more pre-selected entities.

7. The method of claim 1, further comprising receiving contact information for one or more recipients of alert notifications relating to the feedback information.

8. The method of claim 1, wherein the request to the one or more pre-selected entities comprises a uniform resource locator (URL) to a validation webpage that comprises information relating to the one or more pre-selected entities.

9. The method of claim 1, wherein the request to the one or more pre-selected entities comprises a security token, and wherein the security token provides access to one or more survey questions.

10. A computing device configured to analyze customer feedback information, comprising:
a processor;
memory in electronic communication with the processor, wherein the memory stores computer executable instructions that when executed by the processor cause the processor to perform the steps of:
transmitting a request to one or more pre-selected entities to provide feedback information;
receiving the feedback information;
retrieving previously stored feedback information from a data storage device; and
determining a trending pattern based on the received feedback information and the stored feedback information.

11. The computing device of claim 10, wherein the processor is further configured to perform the step of generating trending data representing the trending pattern.

12. The computing device of claim 10, wherein the processor is further configured to perform the step of storing the received feedback information in the data storage device.

13. The computing device of claim 10, wherein the processor is further configured to perform the step of receiving a list of one or more entities.

14. The computing device of claim 10, wherein the processor is further configured to perform the step of setting a response rate for the one or more pre-selected entities.

15. The computing device of claim 10, wherein the processor is further configured to perform the step of establishing a contact frequency for the one or more pre-selected entities.

16. The computing device of claim 10, wherein the processor is further configured to perform the step of receiving contact information for one or more recipients of alert notifications relating to the feedback information.

17. The computing device of claim 10, wherein the request to the one or more pre-selected entities comprises a uniform resource locator (URL) to a validation webpage that comprises information relating to the one or more pre-selected entities.

18. The computing device of claim 10, wherein the request to the one or more pre-selected entities comprises a security token, and wherein the security token provides access to one or more survey questions.

19. A computer-program product for analyzing customer feedback information, the computer-program product comprising a non-transitory computer-readable storage medium storing computer executable instructions that when executed by a processor cause the processor to perform the steps of:
transmitting a request to one or more pre-selected entities to provide feedback information;
receiving the feedback information;
retrieving previously stored feedback information from a data storage device; and
determining a trending pattern based on the received feedback information and the stored feedback information.

20. The computer-program product of claim 19, wherein the processor is further configured to perform the step of generating trending data representing the trending pattern.
